(19) United States
(12) Patent Application Publication
(10) Pub. No.: US 2014/0132214 A1
(43) Pub. Date: May 15, 2014

(54) ELECTRICALLY POWERED VEHICLE AND METHOD FOR CONTROLLING ELECTRICALLY POWERED VEHICLE

(71) Applicant: Tomoya Katanoda, Toyota-shi (JP)

(72) Inventor: Tomoya Katanoda, Toyota-shi (JP)

(73) Assignee: TOYOTA JIDOSHA KABUSHIKI KAISHA, Toyota-shi (JP)

(21) Appl. No.: 14/126,584

(22) PCT Filed: Jun. 17, 2011
(86) PCT No.: PCT/JP2011/063943

§ 371 Date: Dec. 16, 2013

(51) Int. Cl. B60L 11/18

(52) U.S. Cl. CPC B60L 11/1811
USPC 320/109

(57) ABSTRACT

An electrically powered vehicle includes: a rechargeable power storage device; an external charging structure configured to charge the power storage device using a power source external to the vehicle; and a control device that controls the charging of the power storage device such that a value of state of charge of the power storage device does not exceed an upper limit value of the value of state of charge during the charging of the power storage device by the external charging structure, the upper limit value being defined in association with a fully charged state of the power storage device. The control device increases the upper limit value in accordance with progression of deterioration of the power storage device. The control device changes an amount of change for the upper limit value in accordance with a temperature change of the power storage device.

### TECHNICAL FIELD

The present invention relates to an electrically powered vehicle and a method for controlling the electrically powered vehicle, more particularly, charging control for a power storage device provided in the electrically powered vehicle.

### BACKGROUND ART

An electrically powered vehicle configured to be capable of generating vehicle driving power using a motor, such as an electric vehicle, a hybrid vehicle, or a fuel cell vehicle, is provided with a power storage device that stores electric power for driving the motor. In such an electrically powered vehicle, during starting or acceleration, electric power is supplied from the power storage device to the motor so as to generate vehicle driving power. On the other hand, during traveling on a downhill or deceleration, electric power generated by regenerative braking of the motor is supplied to the power storage device. Accordingly, the power storage device is repeatedly discharged and charged during vehicle traveling, so that control is required to manage a state of charge (hereinafter, also simply referred to as “SOC”) of the power storage device during the vehicle traveling. It should be noted that the SOC represents a ratio of a present amount of charges to a fully charged capacity. Generally, charging/discharging of the power storage device is controlled such that the SOC does not fall out of a predetermined control range.

As one manner of such SOC control for the electrically powered vehicle, Japanese Patent Laying-Open No. 2002-345165 (PTD 1) discloses a vehicle battery control device configured to change a control target value of SOC in accordance with a temperature of the battery. In Japanese Patent Laying-Open No. 2002-345165 (PTD 1), the SOC target value is set to be larger as the battery temperature is lower, thereby suppressing output shortage at a low temperature and securing a required output irrespective of the temperature.

Meanwhile, Japanese Patent Laying-Open No. 2005-65352 (PTD 2) discloses a control device that controls charging/discharging of a battery such that the battery capacity falls within a capacity control range having a constant width defined by an upper limit value and a lower limit value. In Japanese Patent Laying-Open No. 2005-65352 (PTD 2), when it is determined that a memory effect takes place in the battery, the control device changes the capacity control range while maintaining the width of the capacity control range to be constant.

### CITATION LIST

### Patent Document

PTD 1: Japanese Patent Laying-Open No. 2002-345165

PTD 2: Japanese Patent Laying-Open No. 2005-65352

PTD 3: Japanese Patent Laying-Open No. 2008-54439

PTD 4: Japanese Patent Laying-Open No. 2001-292533

### SUMMARY OF INVENTION

### Technical Problem

Here, it is known that performance of a secondary battery, which is representatively used as the power storage device, is decreased as deterioration thereof proceeds. For example, the fully charged capacity of the secondary battery is decreased as the deterioration thereof proceeds. Therefore, as a utilization period of the power storage device becomes longer, the fully charged capacity thereof is decreased, with the result that the electrically powered vehicle can possibly travel a shorter distance (hereinafter, also referred to as “cruising distance of the electrically powered vehicle”) using the electric power stored in the secondary battery. Hence, the deterioration of the power storage device also needs to be reflected in the control for the SOC of the power storage device.

Accordingly, the present invention has been made to solve such a problem and has an object to control charging of a power storage device of a vehicle appropriately in a reflection of a degree of deterioration of the power storage device so as to suppress the deterioration of the power storage device and secure a cruising distance.

### Solution to Problem

According to a certain aspect of the present invention, an electrically powered vehicle includes: a rechargeable power storage device; a motor configured to receive electric power supplied from the power storage device and generate vehicle driving power; an external charging structure configured to charge the power storage device using a power source external to the vehicle; and a control device that controls the charging of the power storage device such that a value of state of charge of the power storage device does not exceed an upper limit value of the value of state of charge during the charging of the power storage device by the external charging structure, the upper limit value being defined in association with a fully charged state of the power storage device. The control device is configured to increase the upper limit value in accordance with progression of deterioration of the power storage device. An amount of change for the upper limit value is set to be valuable in accordance with a temperature change of the power storage device.

Preferably, in a case where the temperature of the power storage device is changed within a high temperature range, the control device sets the amount of change for the upper limit value at a value smaller than a value set in a case where the temperature of the power storage device is changed within a low temperature range.

Preferably, when a utilization period of the power storage device reaches a first period, the control device is configured to increase the upper limit value, and change the amount of change for the upper limit value in accordance with the temperature change of the power storage device, the temperature change being obtained whenever a second period elapses. The second period is set at a period shorter than the first period.

Preferably, the electrically powered vehicle further includes an input unit configured to be capable of receiving an instruction regarding the upper limit value from a user. The instruction regarding the upper limit value includes an instruction for restricting the upper limit value to be equal to or more than a predetermined lower limit value.

Preferably, the electrically powered vehicle further includes an input unit configured to be capable of receiving information regarding a destination. When the input unit receives the information regarding the destination, the control device sets the upper limit value at a value set based on a necessary amount of charges to the power storage device for arrival at the destination.

Preferably, the control device sets the necessary amount of electric power based on an amount of electric power to be consumed by the electrically powered vehicle for arrival at the destination.

Preferably, the electrically powered vehicle further includes a display unit configured to be capable of displaying a destination candidate and a recommended value of the upper limit value in association with each other, the destination candidate being selectable by a user, the recommended value being set for the candidate based on the necessary amount of charges to the power storage device. The information regarding the destination includes an instruction regarding the upper limit value from the user.

According to another aspect of the present invention, there is provided a method for controlling an electrically powered vehicle. The electrically powered vehicle includes: a rechargeable power storage device; a motor configured to receive electric power supplied from the power storage device and generate vehicle driving power; and an external charging structure configured to charge the power storage device using a power source external to the vehicle. The method includes the steps of: controlling the charging of the power storage device such that a value of state of charge of the power storage device does not exceed an upper limit value of the value of state of charge during the charging of the power storage device by the external charging structure, the upper limit value being defined in association with a fully charged state of the power storage device; increasing the upper limit value in accordance with progression of deterioration of the power storage device; and changing an amount of change for the upper limit value in accordance with a temperature change of the power storage device.

### Advantageous Effects of Invention

According to the present invention, by performing charging control for the power storage device in a reflection of a degree of deterioration of the power storage device of the vehicle, the cruising distance of the electrically powered vehicle can be secured while suppressing deterioration of the power storage device.

### BRIEF DESCRIPTION OF DRAWINGS

FIG. 1 is a schematic configuration diagram of an electrically powered vehicle according to a first embodiment of the present invention.

FIG. 2 is a function block diagram illustrating charging/discharging control for a power storage device provided in the electrically powered vehicle according to the first embodiment of the present invention.

FIG. 3 illustrates a correlation between years of utilization of a lithium ion battery and a capacity maintenance ratio of the lithium ion battery.

FIG. 4 illustrates setting of a SOC reference range in the electrically powered vehicle of the first embodiment.

FIG. 5 illustrates a cruising distance in a long life mode and a cruising distance in a normal mode.

FIG. 6 illustrates a correlation between years of utilization of the lithium ion battery and a capacity maintenance ratio of the lithium ion battery.

FIG. 7 is a conceptual view illustrating setting of a reference upper limit value corresponding to the years of utilization of the power storage device.

FIG. 8 shows an exemplary amount-of-change setting map for the reference upper limit value.

FIG. 9 is a conceptual view illustrating setting of a reference upper limit value corresponding to a traveling distance of the electrically powered vehicle.

FIG. 10 shows another exemplary amount-of-change setting map for the reference upper limit value.

FIG. 11 is a function block diagram illustrating the configuration of charging/discharging control unit 150 of FIG. 2 more in detail.

FIG. 12 is a flowchart showing a control process procedure for implementing the charging control for the power storage device by charging/discharging control unit 150 of FIG. 11.

FIG. 13 is a flowchart illustrating a process in a step S04 of FIG. 12 more in detail.

FIG. 14 is a conceptual view illustrating a cruising distance of the electrically powered vehicle, which can be achieved in accordance with the SOC control in the first embodiment.

FIG. 15 is a schematic configuration diagram of an electrically powered vehicle according to a second embodiment of the present invention.

FIG. 16 is a flowchart illustrating charging control for a power storage device by the electrically powered vehicle according to the second embodiment of the present invention.

FIG. 17 is a flowchart illustrating charging control for a power storage device by an electrically powered vehicle according to a modification of the second embodiment of the present invention.

FIG. 18 shows an exemplary recommended reference upper limit value setting table.

### DESCRIPTION OF EMBODIMENTS

The following describes embodiments of the present invention in detail with reference to figures. It should be noted that the same or corresponding portions in the figures are given the same reference characters and are not described repeatedly.

### FIRST EMBODIMENT

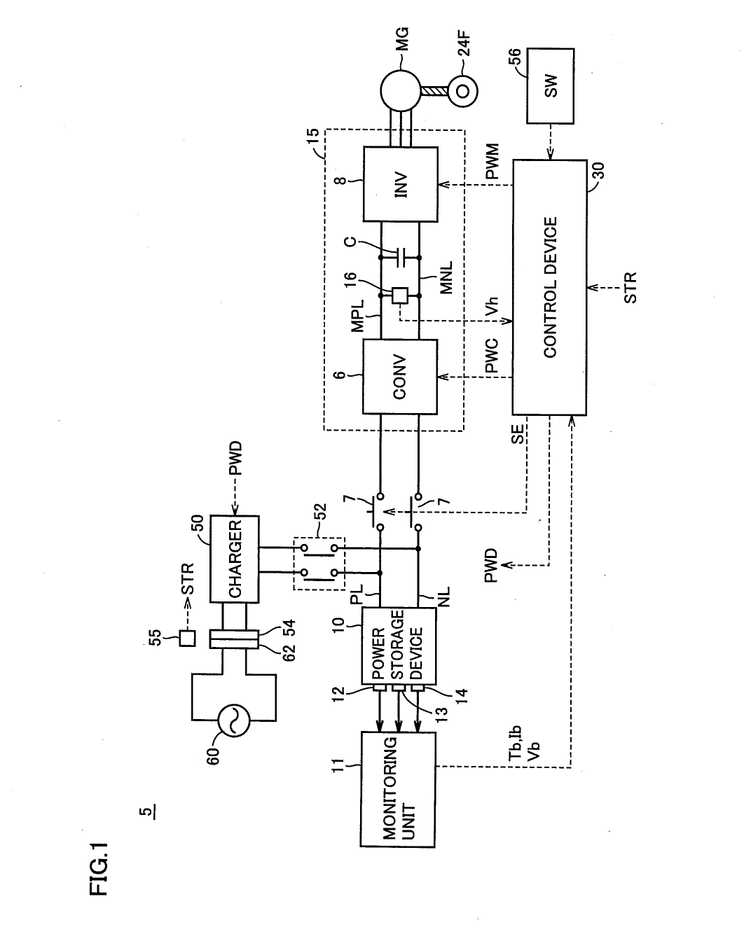

FIG. 1 is a schematic configuration diagram of an electrically powered vehicle 5 according to a first embodiment of the present invention. In the first embodiment, an electric vehicle is illustrated as electrically powered vehicle 5, but the configuration of electrically powered vehicle 5 is not limited to this. The present invention can be applied to any vehicle capable of traveling using electric power from power storage device 10. Examples of electrically powered vehicle 5 include a hybrid vehicle, a fuel cell vehicle, and the like in addition to the electric vehicle.

Referring to FIG. 1, electrically powered vehicle 5 includes a motor generator MG, and a power storage device 10 that can receive/supply electric power from/to motor generator MG.

Power storage device 10 is a re-dischargeable power storage element. Representatively, a secondary battery is applied thereto, such as a lithium ion battery or a nickel hydride battery. Alternatively, power storage device 10 may be constructed of a power storage element other than a battery, such as an electric double layer capacitor. FIG. 1 shows a system configuration associated with charging/discharging control for power storage device 10 in electrically powered vehicle 5.

A monitoring unit 11 detects a “state value” of power storage device 10 based on respective outputs of a temperature sensor 12, a voltage sensor 13, and a current sensor 14 provided in power storage device 10. Specifically, the “state value” includes temperature Tb, voltage Vb, and current lb of power storage device 10. Because the secondary battery is representatively used as power storage device 10 as described above, temperature Tb, voltage Vb, and current Ib of power storage device 10 will be also referred to as “battery temperature Tb”, “battery voltage Vb”, and “battery current Ib”. Furthermore, battery temperature Tb, battery voltage Vb, and battery current Ib are also collectively referred to as “battery data”.

Temperature sensor 12, voltage sensor 13, and current sensor 14 comprehensively represent temperature sensors, voltage sensors, and current sensors provided in power storage device 10, respectively. In other words, actually, a plurality of temperature sensors 12, voltage sensors 13, and/or current sensors 14 are generally provided.

Motor generator MG is an AC rotating electrical machine, such as a three-phase AC motor generator including a rotor having a permanent magnet embedded therein and a stator having three phase coils connected to one another at a neutral point in the form of Y connection. Output torque from motor generator MG is transmitted to driving wheels 24F via power transmission gears (not shown) including a speed reducer and a power split device, whereby electrically powered vehicle 5 travels. Motor generator MG is capable of generating electric power using rotational force from driving wheels 24F during regenerative braking of electrically powered vehicle 5.

The electric power thus generated is converted by an inverter 8 into charging power for power storage device 10.

Electrically powered vehicle 5 further includes a power control unit 15. Power control unit 15 is configured to bidirectionally convert electric power between motor generator MG and power storage device 10. Power control unit 15 includes a converter (CONV) 6 and inverter (INV) 8.

Converter (CONV) 6 is configured to bidirectionally convert DC voltage between power storage device 10 and a positive bus MPL, which transfers a DC link voltage of inverter 8. Namely, the input/output voltage of power storage device 10 and the DC voltage between positive bus MPL and negative bus MNL are bidirectionally stepped up or down. The operation of stepping up or down in converter 6 is controlled in accordance with a switching command PWC from control device 30. Further, a smoothing capacitor C is connected between positive bus MPL and negative bus MNL. Further, DC voltage Vh between positive bus MPL and negative bus MNL is detected by a voltage sensor 16.

Inverter 8 bidirectionally converts electric power between the DC power of positive bus MPL and negative bus MNL and the AC power supplied to/from motor generator MG. Specifically, in accordance with a switching command PWM from control device 30, inverter 8 converts DC power supplied via positive bus MPL and negative bus MNL into AC power, and supplies it to motor generator MG. In this way, motor generator MG generates driving power for electrically powered vehicle 5.

Meanwhile, during regenerative braking of electrically powered vehicle 5, motor generator MG generates AC power as the speed of driving wheels 24F is reduced. In doing so, in accordance with switching command PWM from control device 30, inverter 8 converts the AC power generated by motor generator MG into DC power, and supplies it to positive bus MPL and negative bus MNL. Accordingly, while reducing speed or traveling down a sloping road, power storage device 10 is charged.

Between power storage device 10 and power control unit 15, a system main relay 7 is provided which is inserted in and connected to positive line PL and negative line NL. System main relay 7 is turned on/off in response to a relay control signal SE from control device 30. System main relay 7 is employed as a representative example of an “opening/closing device” capable of interrupting the charging/discharging path for power storage device 10. Any type of opening/closing device can be employed instead of system main relay 7.

Electrically powered vehicles 5 further includes a charging relay 52, a charger 50, a connector receiving portion 54, and a sensor 55 as a configuration for charging power storage device 10 using electric power from a power source (hereinafter, also referred to as “external power source”) 60 external to the vehicle (so-called “plug-in charging”).

When connector portion 62 is connected to connector receiving portion 54, electric power is supplied from external power source 60 to charger 50. External power source 60 is an AC commercial power source of 100V, for example. Sensor 55 detects a state of connection between connector portion 62 and connector receiving portion 54. When sensor 55 detects that connector portion 62 is connected to connector receiving portion 54, sensor 55 outputs a signal STR indicating that power storage device 10 has been brought into a state in which power storage device 10 can be externally charged. On the other hand, when sensor 55 detects that connector portion 62 is disconnected from connector receiving portion 54, sensor 55 stops outputting signal STR.

Charger 50 is a device for receiving electric power from external power source 60 and charging power storage device 10. Control device 30 instructs charger 50 on a charging current and a charging voltage. Charger 50 converts AC into DC, adjusts the voltage, and feeds it to power storage device 10. For the external charging, electrically powered vehicle 5 may be alternatively configured to receive electric power supplied from the external power source by means of electromagnetic coupling without contact between the external power source and the vehicle, specifically, may be configured to receive electric power by means of mutual conductance between a primary coil provided at the external power source side and a secondary coil provided at the vehicle side.

Electrically powered vehicles 5 further includes a switch 56 configured to be operable by a user. Switch 56 is switched between ON state and OFF state by manual operation of the user. When switch 56 is brought into ON state by the user, a command (signal SLF) is generated to set a charging mode of power storage device 10 so as to suppress progression of deterioration of power storage device 10. By suppressing the progression of deterioration of power storage device 10, utilization period of power storage device 10 can be made longer. In other words, signal SLF is a command for attaining a longer utilization period of power storage device 10. In the description below, the charging mode for suppressing progression of deterioration of power storage device 10 is also referred to as “long life mode”.

When switch 56 is brought into OFF state by the user, the generation of signal SLF is stopped. In this way, the setting of the long life mode is canceled and electrically powered vehicle 5 is switched from the long life mode to a normal mode. Specifically, by turning on or off switch 56, the user can select one of the long life mode and the normal mode as the charging mode of electrically powered vehicle 5.

Control device 30 is representatively constructed of an electronic control unit (ECU). The ECU is mainly constructed of a CPU (Central Processing Unit); a memory region such as a RAM (Random Access Memory) or a ROM (Read Only Memory); and an input/output interface. In control device 30, the CPU reads out, to the RAM, a program stored in advance in the ROM and executes it, thereby performing control associated with the vehicle traveling and the charging/discharging. It should be noted that at least a part of the ECU may be configured to perform predetermined mathematical/logical calculation process using hardware such as an electronic circuit.

As exemplary information sent to control device 30, FIG. 1 illustrates the battery data (battery temperature Tb, battery voltage Vb, and battery current Ib), DC voltage Vh, and signal SLF. The battery data is provided from monitoring unit 11 and DC voltage Vh is provided from voltage sensor 16 positioned between the lines of positive bus MPL and negative bus MNL. Signal SLF is provided from switch 56. Although not shown in the figure, a current detection value of each phase of motor generator MG and a rotation angle detection value of motor generator MG are also sent to control device 30.

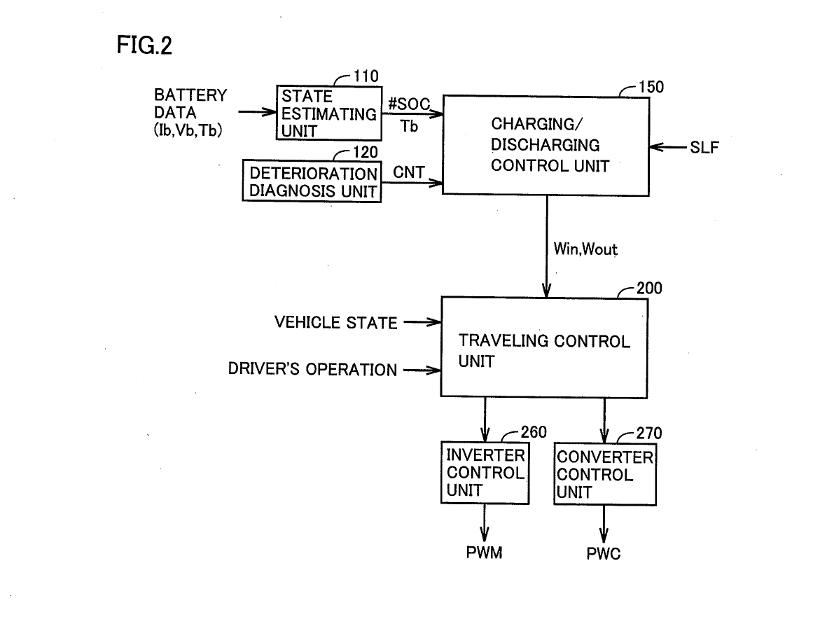

FIG. 2 is a function block diagram illustrating charging/discharging control for the power storage device in electrically powered vehicle 5 according to the first embodiment of the present invention. It should be noted that each functional block in each of the below-mentioned block diagrams inclusive of FIG. 2 can be implemented by control device 30 performing software processing in accordance with a program set in advance. Alternatively, a circuit (hardware) having a function corresponding to the function can be provided in control device 30.

Referring to FIG. 2, a state estimating unit 110 estimates a state of charge (SOC) of power storage device 10 based on the battery data (Tb, Vb, Ib) sent from monitoring unit 11. The SOC represents a ratio of a present amount of charges to a fully charged capacity (0% to 100%). For example, state estimating unit 110 sequentially calculates an SOC estimate value (#SOC) of power storage device 10 based on an integrated value of the charging amount and discharging amount of power storage device 10. The integrated value of the charging amount and discharging amount is obtained by temporally integrating a product (electric power) of battery current Ib and battery voltage Vb. Alternatively, the SOC estimate value (#SOC) may be found based on a relation between an open circuit voltage (OCV) and the SOC.

Deterioration diagnosis unit 120 measures years of utilization of power storage device 10 as a deterioration parameter used to estimate a degree of deterioration of power storage device 10. The deterioration of power storage device 10 proceeds as the years of utilization become longer. When the deterioration of power storage device 10 proceeds, the fully charged capacity of power storage device 10 is decreased and the internal resistance is increased. It should be noted that factors for the deterioration of power storage device 10 include not only the years of utilization of power storage device 10 but also traveling distance of electrically powered vehicle 5. Hence, deterioration diagnosis unit 120 may measure the traveling distance of electrically powered vehicle 5 as the deterioration parameter, instead of the years of utilization of power storage device 10. Alternatively, the years of utilization of power storage device 10 and the traveling distance of electrically powered vehicle 5 may be measured. It should be noted that the years of utilization of power storage device 10 and the traveling distance of electrically powered vehicle 5 can be calculated using various well-known methods.

The SOC estimate value (#SOC) calculated by state estimating unit 110, the battery data from monitoring unit 11, and years of utilization CNT of power storage device 10 measured by deterioration diagnosis unit 120 are sent to a charging/discharging control unit 150. The battery data sent to charging/discharging control unit 150 at least includes battery temperature Tb.

Based on the state of power storage device 10, charging/discharging control unit 150 sets maximum electric power values permitted for charging/discharging of power storage device 10 (charging power upper limit value Win and discharging power upper limit value Wout).

A traveling control unit 200 calculates vehicle driving power and vehicle braking power required in the entire electrically powered vehicle 5, in accordance with the vehicle state of electrically powered vehicle 5 and a driver's operation. The driver's operation includes an amount of stepping on an accelerator pedal (not shown), a position of a shift lever (not shown), an amount of stepping on a brake pedal (not shown), or the like.

Further, traveling control unit 200 determines an output request for motor generator MG in order to achieve the requested vehicle driving power or vehicle braking power. Further, the output request for motor generator MG is set with charging/discharging of power storage device 10 being restricted in the range of electric power (Win to Wout) chargeable/dischargeable to/from power storage device 10. In other words, when the output electric power of power storage device 10 cannot be secured, the output of motor generator MG is restricted.

In accordance with the set output request for motor generator MG, traveling control unit 200 calculates torque and rotational speed of motor generator MG. Then, traveling control unit 200 sends control commands regarding the torque and rotational speed to an inverter control unit 260, and at the same time, sends a control command value regarding voltage Vh to a converter control unit 270.

In accordance with the control command from traveling control unit 200, inverter control unit 260 generates switching command PWM for driving motor generator MG. This switching command PWM is sent to inverter 8.

In accordance with the control command from traveling control unit 200, converter control unit 270 generates switching command PWC so as to control DC voltage Vh. In accordance with switching command PWC, converter 6 converts voltage so as to control electric power charged to and discharged from power storage device 10.

In this way, traveling control for electrically powered vehicle 5 is achieved to improve energy efficiency in accordance with the vehicle state and the driver's operation.

In electrically powered vehicle 5 according to the first embodiment of the present invention, power storage device 10 can be charged using motor generator MG during regenerative braking of the vehicle. After ending the traveling, power storage device 10 can be charged in a plug-in manner. In the description below, charging power storage device 10 using external power source 60 is also referred to as “external charging” and charging power storage device 10 using motor generator MG during regenerative braking of the vehicle is also referred to as “internal charging” for discrimination of the respective charging operations.

In electrically powered vehicle 5 of such a plug-in type, power storage device 10 has been externally charged up to a reference upper limit value Smax at the start of vehicle traveling. Reference upper limit value Smax is a determination value for determining whether or not the SOC of power storage device 10 has reached the fully charged state during the external charging of power storage device 10.

When the ignition switch is turned on to instruct traveling of electrically powered vehicle 5, the SOC of power storage device 10 is gradually decreased due to the traveling of electrically powered vehicle 5. When the SOC estimate value (#SOC) is decreased to the lower limit value of the control range, the traveling of electrically powered vehicle 5 is ended.

It should be noted that the SOC control range for the traveling is set independently of the control range for the external charging. For example, during regenerative braking of electrically powered vehicle 5, the SOC of power storage device 10 is increased by regenerative electric power generated by motor generator MG. As a result, the SOC may become higher than reference upper limit value Smax for the external charging of power storage device 10. However, as the traveling of electrically powered vehicle 5 is continued, the SOC is decreased again. In other words, during the traveling of electrically powered vehicle 5, a high SOC state is less likely to be continued for a long time. Hence, the SOC control range for the traveling can be set independently of the control range for the external charging.

When the traveling of electrically powered vehicle 5 is ended, the driver connects connector portion 62 (FIG. 1) to electrically powered vehicle 5, thereby starting external charging. Accordingly, the SOC of power storage device 10 starts to be increased.

By performing the external charging after the traveling of electrically powered vehicle 5 in this way, power storage device 10 can be almost fully charged.

Accordingly, a large amount of electric power can be derived from power storage device 10, so that a longer cruising distance of electrically powered vehicle 5 can be achieved. It should be noted that the term “cruising distance” in the present specification is intended to mean a distance that can be travelled by electrically powered vehicle 5 using electric power stored in power storage device 10. In particular, when a lithium ion battery having high energy density is employed as power storage device 10, a large amount of electric power can be derived from power storage device 10 and power storage device 10 can be downsized and reduced in weight.

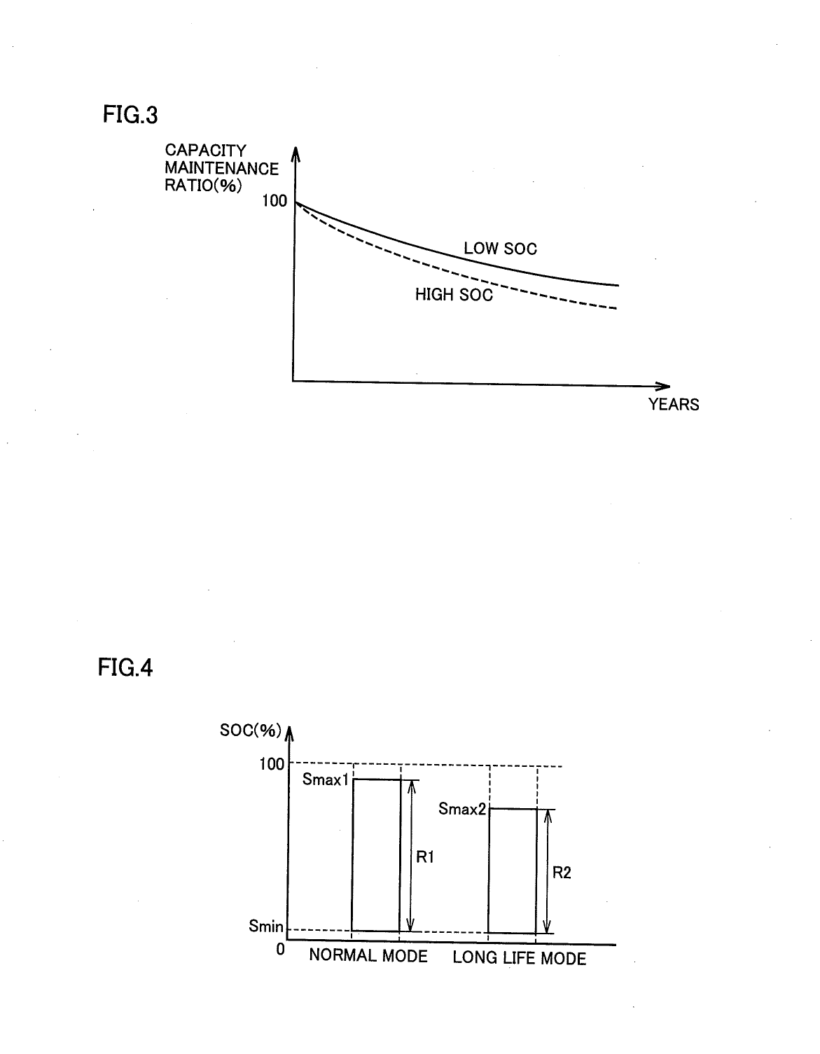

However, generally, in view of deterioration, it is not preferable that the high SOC state is continued in the lithium ion battery for a long time. For example, as the deterioration of the lithium ion battery proceeds, the fully charged capacity is decreased. FIG. 3 illustrates a correlation between the years of utilization of the lithium ion battery and a capacity maintenance ratio of the lithium ion battery. Referring to FIG. 3, when the lithium ion battery is brand new, the capacity maintenance ratio is defined as “100%”. With electrically powered vehicle 5 repeatedly traveling using electric power stored in the lithium ion battery, the lithium ion battery gradually becomes deteriorated. As the years of utilization of the lithium ion battery become longer, the capacity maintenance ratio becomes smaller. In other words, the fully charged capacity of the lithium ion battery is decreased. Further, a degree of the decrease of the capacity maintenance ratio corresponding to the years of utilization becomes larger as the SOC is higher when completing the charging of the lithium ion battery.

Here, a period of time from completion of charging of power storage device 10 to start of traveling of electrically powered vehicle 5 differs depending on users. Hence, the high SOC state may be continued for a long time. Accordingly, the fully charged capacity of power storage device 10 may be decreased.

Electrically powered vehicle 5 according to the first embodiment has the long life mode for achieving a longer utilization period of power storage device 10. In the first embodiment, the SOC control for power storage device 10 is switched in the following manner between the normal mode and the long life mode.

FIG. 4 illustrates setting of a SOC reference range in electrically powered vehicle 5 of the first embodiment. In the present specification, the “SOC reference range” is the SOC control range for the external charging, and is set independently of the SOC control range for the traveling as described above. In the description below, the lower limit of the SOC reference range is referred to as “Smin (reference lower limit value)”, and the upper limit of the SOC reference range is referred to as “Smax (reference upper limit value)”. Reference upper limit value Smax and reference lower limit value Smin respectively correspond to the fully charged state and the empty state both provided for the SOC control so as to avoid overcharging or overdischarging reaching or exceeding these values.

Reference upper limit value Smax is a determination value for determining whether or not the SOC of power storage device 10 has reached the fully charged state during the external charging. In electrically powered vehicle 5 according to the present embodiment, this reference upper limit value Smax is switched between the normal mode and the long life mode.

Referring to FIG. 4, a first range R1 is a SOC reference range in the normal mode. A second range R2 is a SOC reference range in the long life mode. Smax1represents the upper limit value of first range R1, i.e., reference upper limit value Smax in the normal mode. Smax2 represents the upper limit value of second range R2, i.e., reference upper limit value Smax in the long life mode. Further, the lower limit value of first range R1, i.e., the reference lower limit value in the normal mode, and the lower limit value of second range R2, i.e., the reference lower limit value in the long life mode are both Smin. However, the lower limit value of second range R2 may be larger than the lower limit value of first range R1.

Each of reference upper limit values Smax1 and Smax2 is set at a value smaller than 100% in order to prevent overcharging of power storage device 10. Further, reference lower limit value Smin is set at a value larger than 0% in order to prevent overdischarging of power storage device 10.

Here, reference upper limit value Smax2 in the long life mode is set at a value smaller than reference upper limit value Smax1 in the normal mode. Accordingly, in the long life mode, the SOC upon completion of charging of power storage device 10 can be made lower than that in the normal mode. As a result, during the long life mode, progression of deterioration of power storage device 10 can be suppressed.

When power storage device 10 is charged in the long life mode in this way, the fully charged capacity of power storage device 10 can be suppressed from being decreased. As a result, even when the years of utilization of power storage device 10 become long, the cruising distance of electrically powered vehicle 5 can be secured.

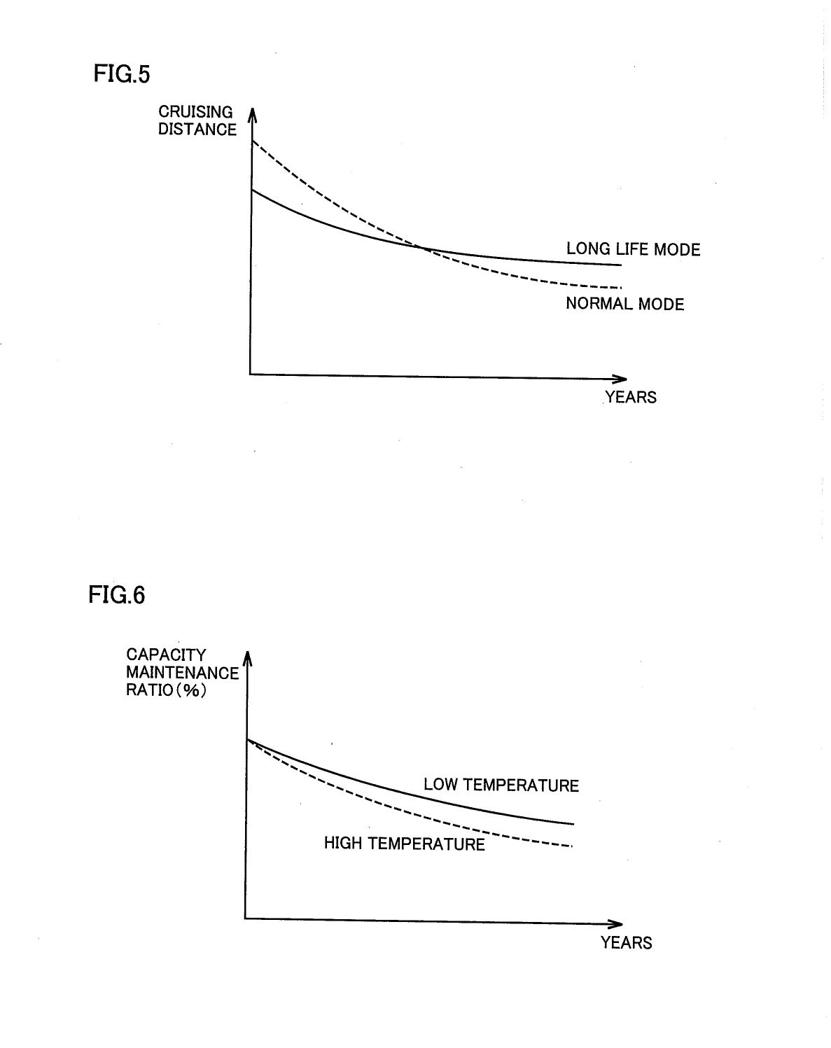

FIG. 5 illustrates the cruising distance in the long life mode and the cruising distance in the normal mode.

Referring to FIG. 5, when the years of utilization of power storage device 10 are short, the degree of deterioration of power storage device 10 is small, so that power storage device 10 can store a large amount of electric power. Accordingly, when the years of utilization of power storage device 10 are short, the cruising distance in the normal mode is longer than that in the long life mode.

By charging power storage device 10 assuming that reference upper limit value Smax is a limit, deterioration of power storage device 10 proceeds. However, in the long life mode, progression of deterioration of power storage device 10 is suppressed as compared with the normal mode. Hence, even when the years of utilization of power storage device 10 become long, power storage device 10 can store a larger amount of electric power. As a result, electrically powered vehicle 5 can travel a cruising distance longer than that in the normal mode.

Meanwhile, even though the long life mode is selected for the charging mode, deterioration of power storage device 10 (decrease of the fully charged capacity) proceeds as the years of utilization of power storage device 10 become longer. Accordingly, as the years of utilization of power storage device 10 become longer, the cruising distance of electrically powered vehicle 5 becomes shorter.

Here, when the long life mode is selected as the charging mode of power storage device 10 in electrically powered vehicle 5 according to the first embodiment, reference upper limit value Smax2 is increased in accordance with progression of deterioration of power storage device 10. Specifically, reference upper limit value Smax2 is increased when a condition is established such that a deterioration parameter indicating a degree of deterioration of power storage device 10 has reached a predetermined level. As the deterioration parameter, at least one of the years of utilization of power storage device 10 and the traveling distance of electrically powered vehicle 5 can be employed. The deterioration of power storage device 10 proceeds as the years of utilization of power storage device 10 become longer, or as the traveling distance of electrically powered vehicle 5 becomes longer. In the first embodiment, reference upper limit value Smax2 is increased whenever certain years y0 elapse with regard to the years of utilization of power storage device 10.

With such a configuration, as the years of utilization of power storage device 10 become longer, reference upper limit value Smax2 is increased at the timing set in advance in accordance with the degree of deterioration of power storage device 10.

As shown in FIG. 3, as the years of utilization of power storage device 10 become longer, the fully charged capacity of power storage device 10 is decreased. Accordingly, if reference upper limit value Smax2 is fixed, the amount of charges in power storage device 10 may not be increased even when power storage device 10 is charged. As a result, the cruising distance of electrically powered vehicle 5 may not attain a target value. To address this, in the first embodiment, reference upper limit value Smax2 is increased at an appropriate timing based on the degree of deterioration of power storage device 10 (degree of decrease of the fully charged capacity), thereby securing the amount of charges in power storage device 10. As a result, the cruising distance of electrically powered vehicle 5 can be made longer.

Here, generally, in view of deterioration, it is not preferable that a high temperature state is continued in a secondary battery such as a lithium ion battery for a long time. FIG. 6 illustrates a correlation between the years of utilization of the lithium ion battery and a capacity maintenance ratio of the lithium ion battery. As illustrated in FIG. 3, as the years of utilization of the lithium ion battery become longer, the capacity maintenance ratio becomes smaller. Moreover, as shown in FIG. 6, the degree of decrease of the capacity maintenance ratio corresponding to the years of utilization in the case where the temperature of power storage device 10 is continued to be high for a long time is larger than that in the case where the temperature of power storage device 10 is continued to be low for a long time.

However, manners of utilization of the vehicle are not the same among users. Some users maintain the temperature of power storage device 10 at a relatively high value after completion of the external charging, whereas other users maintain the temperature of power storage device 10 at a relatively low value. Thus, the degree of progression of deterioration of power storage device 10 becomes different depending on the users. Meanwhile, even in the case of the same user, the degree of progression of deterioration of power storage device 10 becomes different depending on seasons. The state in which the temperature of power storage device 10 is maintained at a high value for a long time is determined as an undesirable state in view of deterioration being continued. This needs to be addressed.

In electrically powered vehicle 5 according to the first embodiment, the temperature (battery temperature Tb) of power storage device 10 is monitored and an amount of change for reference upper limit value Smax2 is changed in accordance with temperature change of power storage device 10. The temperature change is obtained whenever a predetermined period elapses. Specifically, in the case where the temperature of power storage device 10 is changed within a high temperature range during the predetermined period, the amount of change for the upper limit value is set at a smaller value than a value set in the case where the temperature of power storage device 10 is changed within a low temperature range during the predetermined period.

In the case where the temperature of power storage device 10 is changed within the high temperature range, the SOC of power storage device 10 upon completion of charging of power storage device 10 can be made lower than that in the case where the temperature of power storage device 10 is changed within the low temperature range. In this way, progression of deterioration of power storage device 10 can be suppressed.

It should be noted that the “predetermined period” in the present specification is set to at least include a period of time elapsed from the start of the external charging to the start of the traveling of electrically powered vehicle 5. This predetermined period is determined in consideration of how often the user performs external charging, a deterioration characteristic of power storage device 10, and the like. For example, the predetermined period is set at “30 days”.

The control for reference upper limit value Smax2 is performed based on the years of utilization of power storage device 10 whenever certain years y0 elapse, whereas the control for the amount of change for the upper limit value is performed based on the temperature change of power storage device 10 at an interval (time interval or traveling distance interval) shorter than certain years y0. In other words, the predetermined period is set at a period shorter than certain years y0. Thus, reference upper limit value Smax2 is set finely in a reflection of the temperature change of power storage device 10 affecting the battery performance, thereby suppressing progression of deterioration of power storage device 10. As a result, the cruising distance of electrically powered vehicle 5 can be made further longer.

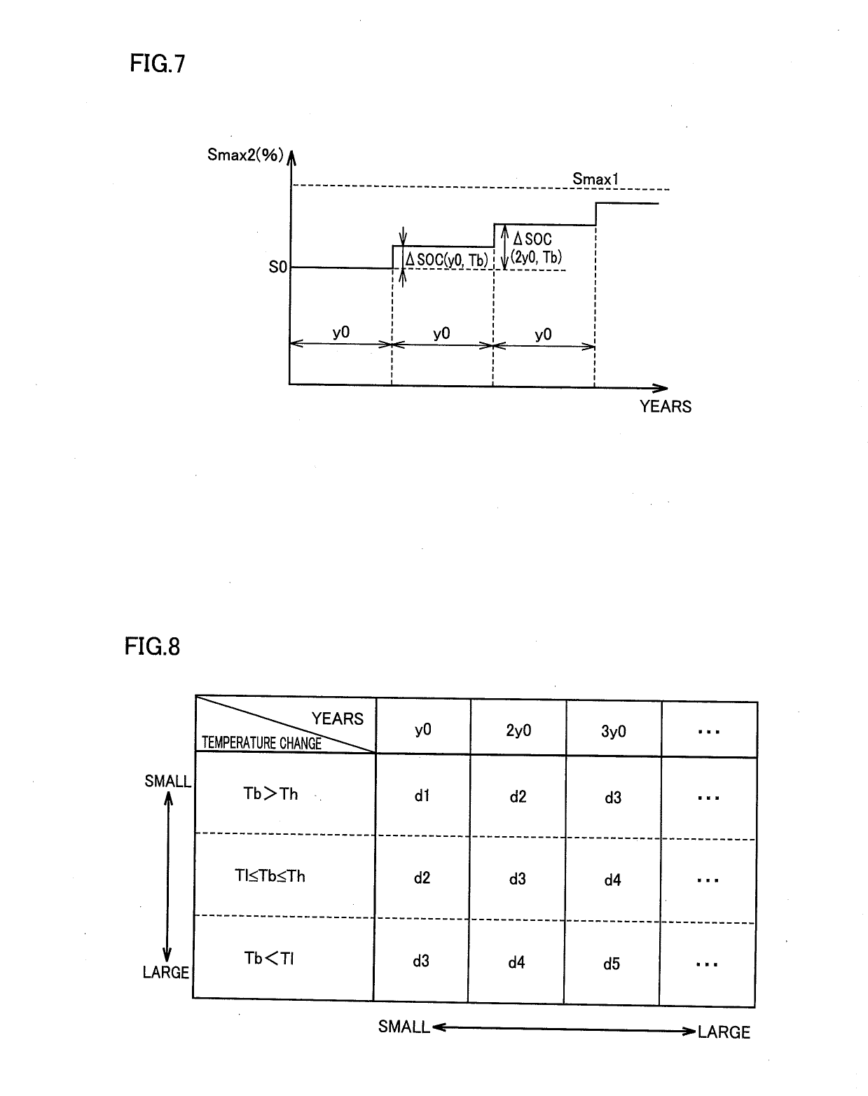

FIG. 7 is a conceptual view illustrating setting of reference upper limit value Smax2 corresponding to the years of utilization of power storage device 10.

Referring to FIG. 7, when power storage device 10 is in a brand new or equivalent state, reference upper limit value Smax2 in the long life mode is set at S0, which is a default value. S0 represents a ratio of the reference capacity to the fully charged capacity of power storage device 10 in the brand new state. The reference capacity is set at a value having a margin for the fully charged capacity. For the reference capacity, the capacity of power storage device 10, which is required to achieve a target value for the cruising distance of electrically powered vehicle 5, is set as a default value. When the capacity of power storage device 10 reaches the reference capacity, the SOC of power storage device 10 reaches reference upper limit value Smax2, so that it is determined that power storage device 10 has reached the fully charged state. In other words, the reference capacity corresponds to a threshold value for determining whether or not power storage device 10 has reached the fully charged state.

As shown in FIG. 3, as the years of utilization of power storage device 10 become longer, the fully charged capacity of power storage device 10 is decreased. Accordingly, if reference upper limit value Smax2 is fixed at default value S0, the cursing distance of electrically powered vehicle 5 does not possibly achieve the target value even though power storage device 10 is charged until the SOC reaches reference upper limit value Smax2 when the years of utilization of power storage device 10 are long.

Hence, based on measurement value CNT from deterioration diagnosis unit 120 (FIG. 2), it is determined that the years of utilization of power storage device 10 have reached predetermined years y0, charging/discharging control unit 150 (FIG. 2) increases reference upper limit value Smax2 from default value S0.

During the utilization period from years y0 to 2y0, amount of change ΔSOC for reference upper limit value Smax2 is set to be variable in accordance with temperature change of power storage device 10 obtained whenever a predetermined period elapses (for example, 30 days). When the years of utilization reaches years 2y0, charging/discharging control unit 150 increases reference upper limit value Smax2. Also during the utilization period from years 2y0 to 3y0, amount of change ΔSOC for reference upper limit value Smax2 is set to be variable in accordance with temperature change of power storage device 10 obtained whenever a predetermined period elapses (for example, 30 days).

Amount of change ΔSOC for reference upper limit value Smax2 is set in advance based on a relation between the temperature change and battery performance of power storage device 10. The relation is found through, for example, an experiment of repeatedly charging and discharging power storage device 10 in accordance with a standard traveling pattern of electrically powered vehicle 5, as well as deterioration test on power storage device 10 or the like. As an amount-of-change setting map for upper limit value, charging/discharging control unit 150 previously stores the relation, found by the experiment and the like, between amount of change ΔSOC for reference upper limit value Smax2 and each of the years of utilization and temperature change of power storage device 10. When charging/discharging control unit 150 obtains the measurement value of the years of utilization and the temperature change in the predetermined period, charging/discharging control unit 150 makes reference to the stored map so as to set a corresponding amount of change ΔSOC for the reference upper limit value. FIG. 8 shows an exemplary amount-of-change setting map for the reference upper limit value. In the figure, amount of change ΔSOC for the reference upper limit value is set to be larger as the years of utilization of power storage device 10 are increased to years y0, 2y0, and 3y0.

Further, when the temperature of power storage device 10 is changed at the high temperature side relative to a predetermined value Th during the predetermined period, amount of change ΔSOC for reference upper limit value is set to be smaller than that in the case where the temperature of power storage device 10 is changed at the low temperature side relative to predetermined value Th. Further, when the temperature of power storage device 10 is changed at the high temperature side relative to a predetermined value T1 (<Th), amount of change ΔSOC for the reference upper limit value is set to be smaller than that in the case where the temperature of power storage device 10 is changed at the low temperature side relative to predetermined value T1.

In other words, as the temperature of power storage device 10 is changed within the higher temperature range, amount of change ΔSOC for the reference upper limit value becomes smaller.

It should be noted that in FIG. 7, reference upper limit value Smax2 is configured to be increased whenever predetermined years y0 elapse with regard to the years of utilization, but the number of times of increasing reference upper limit value Smax2 may be one. The number of times of increasing reference upper limit value Smax2 can be set based on standard years of utilization of power storage device 10, the fully charged capacity of power storage device 10, a target cruising distance, and the like. After reference upper limit value Smax2 is increased at the set timing, amount of change ΔSOC for the reference upper limit value is set to be variable in accordance with the temperature change of power storage device 10 obtained whenever the predetermined period elapses.

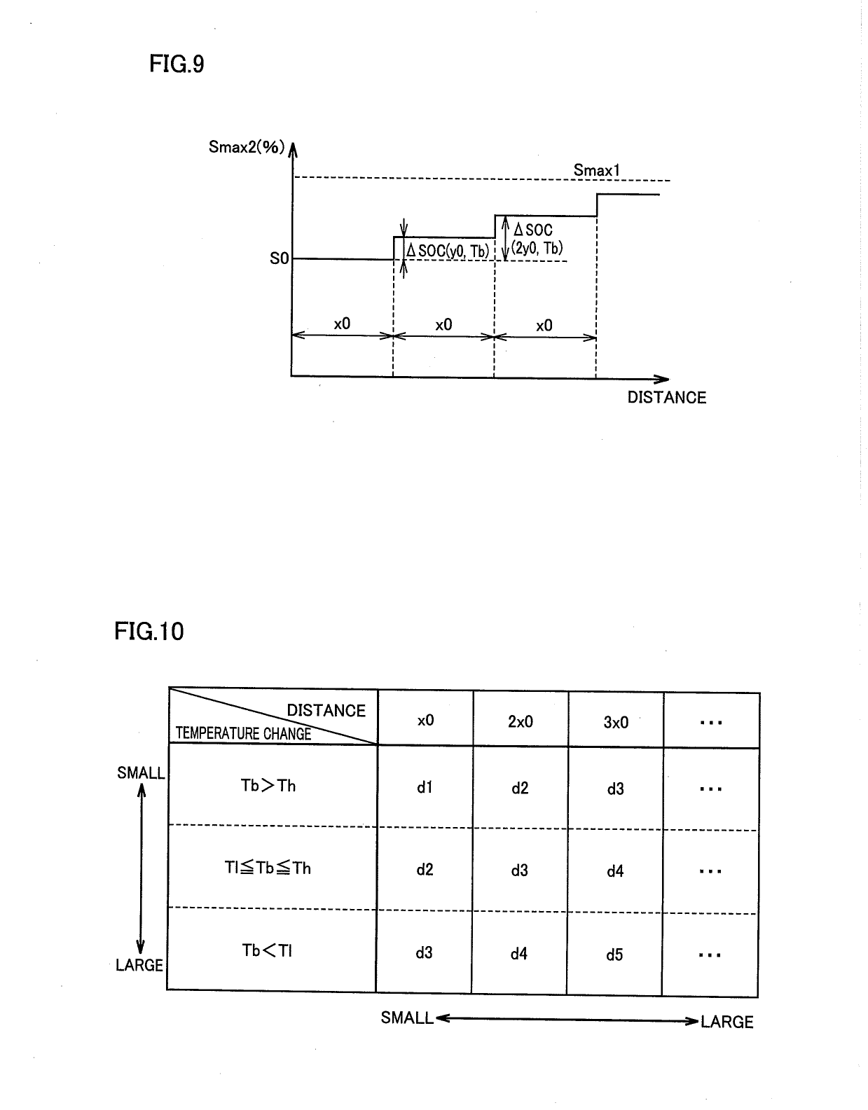

Further, in order to secure a necessary minimum cruising distance, the user may set a lower limit guard value for the reference upper limit value via an input unit (not shown). In this case, amount of change ΔSOC for the reference upper limit value is set such that the reference upper limit value becomes equal to or more than the lower limit guard value. Further, as shown in FIG. 9, reference upper limit value Smax2 may be increased in accordance with the traveling distance of electrically powered vehicle 5. FIG. 9 is a conceptual view illustrating setting of reference upper limit value Smax2corresponding to the traveling distance of electrically powered vehicle 5. Referring to FIG. 9, when it is determined, based on measurement value CNT of traveling distance from deterioration diagnosis unit 120, that the traveling distance of electrically powered vehicle 5 has reached a predetermined distance x0, charging/discharging control unit 150 increases reference upper limit value Smax2 from default value S0 to S1. During a period of time in which the traveling distance is x0 to 2x0, amount of change ΔSOC for reference upper limit value Smax2 (=S1−S0) is set to be variable in accordance with temperature change of power storage device 10 obtained whenever a predetermined period elapses (for example, 30 days). When the traveling distance has reached 2x0, charging/discharging control unit 150 increases reference upper limit value Smax2 from S1 to S2. Also during a period of time in which the traveling distance is 2x0 to 3x0, amount of change ΔSOC for reference upper limit value Smax2 (=S2−S0) is set to be variable in accordance with temperature change of power storage device 10 obtained whenever the predetermined period elapses (for example, 30 days).

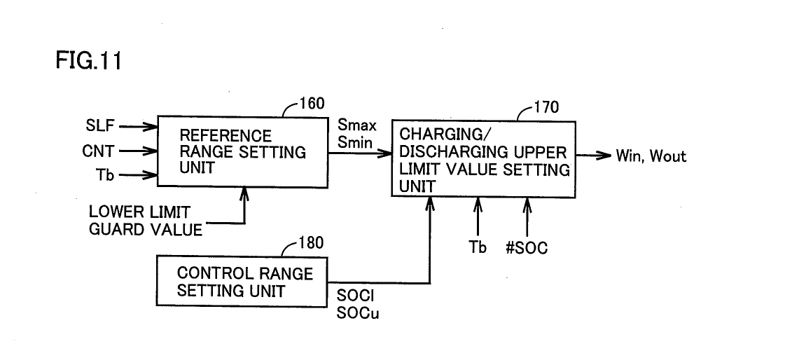

As the amount-of-change setting map for the reference upper limit value, charging/discharging control unit 150 previously stores the relation, found by the experiment and the like, between amount of change ΔSOC for reference upper limit value Smax2 and each of the traveling distance of electrically powered vehicle 5 and the temperature change of power storage device 10. Further, when charging/discharging control unit 150 obtains the measurement value of the traveling distance and the temperature change in the predetermined period, charging/discharging control unit 150 makes reference to the stored map so as to set a corresponding amount of change ΔSOC for the reference upper limit value. FIG. 10 shows one exemplary amount-of-change setting map for the reference upper limit value. In this figure, as the traveling distance of electrically powered vehicle 5 is increased to x0, 2x0, and 3x0, amount of change ΔSOC for the reference upper limit value is set to become larger. Further, as the temperature of power storage device 10 is changed within the high temperature range during the predetermined period, amount of change ΔSOC for the reference upper limit value is set to become smaller.

It should be noted that as with FIG. 7, also in FIG. 9, the number of times of increasing reference upper limit value Smax2 may be one instead of the configuration in which reference upper limit value Smax2 is increased for every predetermined distance x0. The number of times of increasing reference upper limit value Smax2 can be determined in advance based on standard years of utilization of power storage device 10, the fully charged capacity of power storage device 10, a target cruising distance, and the like. After reference upper limit value Smax2 is increased at the set timing, amount of change ΔSOC for the reference upper limit value is set to be variable in accordance with the temperature change of power storage device 10 obtained whenever the predetermined period elapses.

The following describes a control structure for changing reference upper limit value Smax2 in accordance with the above-described years of utilization of power storage device 10 and the temperature change of power storage device 10 during the predetermined period.

FIG. 11 shows the configuration of charging/discharging control unit 150 (FIG. 2) more in detail.

Referring to FIG. 11, charging/discharging control unit 150 includes a reference range setting unit 160, a charging/discharging upper limit value setting unit 170, and a control range setting unit 180.

Reference range setting unit 160 sets the SOC reference range (reference upper limit value Smax and reference lower limit value Smin) of power storage device 10, based on signal SLF from switch 56 (FIG. 1), measurement value CNT of the years of utilization of power storage device 10 from deterioration diagnosis unit 120, and the battery data (battery temperature Tb) from monitoring unit 11. When receiving signal SLF from switch 56, reference range setting unit 160 determines that signal SLF has been generated, i.e., determines that the long life mode has been selected as the charging mode of power storage device 10. On the other hand, when receiving no signal SLF from switch 56, reference range setting unit 160 determines that signal SLF has not been generated, i.e., determines that the normal mode has been selected as the charging mode of power storage device 10.

In the case where the long life mode is selected as the charging mode, reference range setting unit 160 sets the reference upper limit value at Smax2 (FIG. 4). On the other hand, in the case where the normal mode is selected as the charging mode, reference range setting unit 160 sets the reference upper limit value at Smax1 (FIG. 4).

Further, in the case where the long life mode is selected, reference range setting unit 160 increases reference upper limit value Smax2 based on measurement value CNT of the years of utilization of power storage device 10 whenever certain years y0 elapse with regard to the years of utilization of power storage device 10. Specifically, reference range setting unit 160 monitors battery temperature Tb so as to obtain the temperature change of power storage device 10 in the predetermined period. Further, when reference range setting unit 160 obtains measurement value CNT of the years of utilization of power storage device 10 and the temperature change during the predetermined period, reference range setting unit 160 makes reference to the amount-of-change setting map shown in FIG. 8 for the upper limit value so as to set a corresponding amount of change ΔSOC for the upper limit value.

Control range setting unit 180 sets the SOC control range of power storage device 10 for traveling. The SOC control range is set to fall within the range from reference lower limit value Smin to reference upper limit value Smax. Namely, the lower limit (control lower limit value SOC1) and the upper limit (control upper limit value SOCu) of the control range are set to have margins for reference lower limit value Smin and reference upper limit value Smax, respectively.

At least based on battery temperature Tb and SOC estimate value (#SOC), charging/discharging upper limit value setting unit 170 sets maximum charging and discharging power values (charging power upper limit value Win and discharging power upper limit value Wout) permitted in power storage device 10. As the SOC estimate value (#SOC) is decreased, discharging power upper limit value Wout is set to gradually become smaller. In contrast, as the SOC estimate value (#SOC) is increased, charging power upper limit value Win is set to be gradually decreased.

In the configuration shown in FIG. 11, when the SOC estimate value (#SOC) comes close to reference upper limit value Smax during the external charging, charging/discharging upper limit value setting unit 170 sets charging power upper limit value Win to be low. In this way, overcharging of power storage device 10 is avoided.

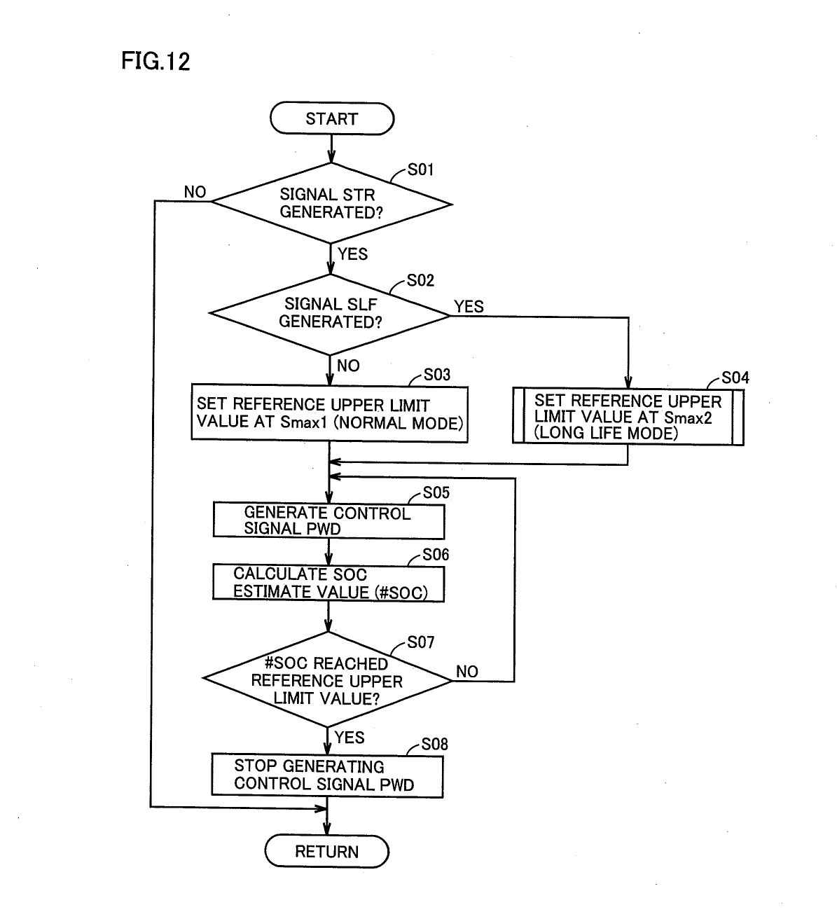

FIG. 12 is a flowchart showing a control process procedure for implementing the charging control for the power storage device by charging/discharging control unit 150 of FIG. 11. It should be noted that the flowchart shown in FIG. 12 is executed whenever a certain time elapses or a predetermined condition is established.

Referring to FIG. 12, in a step S01, charging/discharging control unit 150 determines whether or not signal STR has been generated. When signal STR has not been generated (NO in step S01), charging/discharging control unit 150 determines that the external charging cannot be started. In this case, the process is brought back to the main routine.

On the other hand, when signal STR has been generated (YES in step S01), charging/discharging control unit 150 determines that the external charging can be started. In this case, in a step S02, charging/discharging control unit 150 determines whether or not signal SLF has been generated. When it is determined that signal SLF has not been generated (NO in step S02), charging/discharging control unit 150 sets in a step S03 the reference upper limit value of the SOC of power storage device 10 at Smax1. In this way, the charging mode is set at the normal mode.

Meanwhile, when it is determined that signal SLF has been generated (YES in step S02), charging/discharging control unit 150 sets in a step S04 the reference upper limit value of the SOC at Smax2. In this way, the charging mode is set at the long life mode. Namely, the processes in steps S02 to S04 correspond to the function of reference range setting unit 160 shown in FIG. 11.

Next, in a step S05, charging/discharging control unit 150 generates control signal PWD for providing charger 50 with an instruction on charging current and charging voltage. In accordance with control signal PWD, charger 50 converts the AC power supplied from external power source 60 into DC power. Power storage device 10 is charged with the DC power supplied from charger 50.

In a step S06, state estimating unit 110 (FIG. 2) estimates the SOC of power storage device 10 based on the battery data from monitoring unit 11. When charging/discharging control unit 150 obtains the SOC estimate value (#SOC) calculated by state estimating unit 110, charging/discharging control unit 150 determines in a step S07 whether or not the SOC estimate value (#SOC) has reached reference upper limit value Smax. When it is determined that the SOC estimate value (#SOC) has reached reference upper limit value Smax (YES in step S07), charging/discharging control unit 150 stops generating the control signal. In this way, the external charging of power storage device 10 is ended. On the other hand, when it is determined that the SOC estimate value (#SOC) has not reached reference upper limit value Smax (NO in step S07), the process is brought back to step S05. Until the SOC estimate value (#SOC) reaches reference upper limit value Smax, the processes of steps S05 to S07 are repeatedly performed.

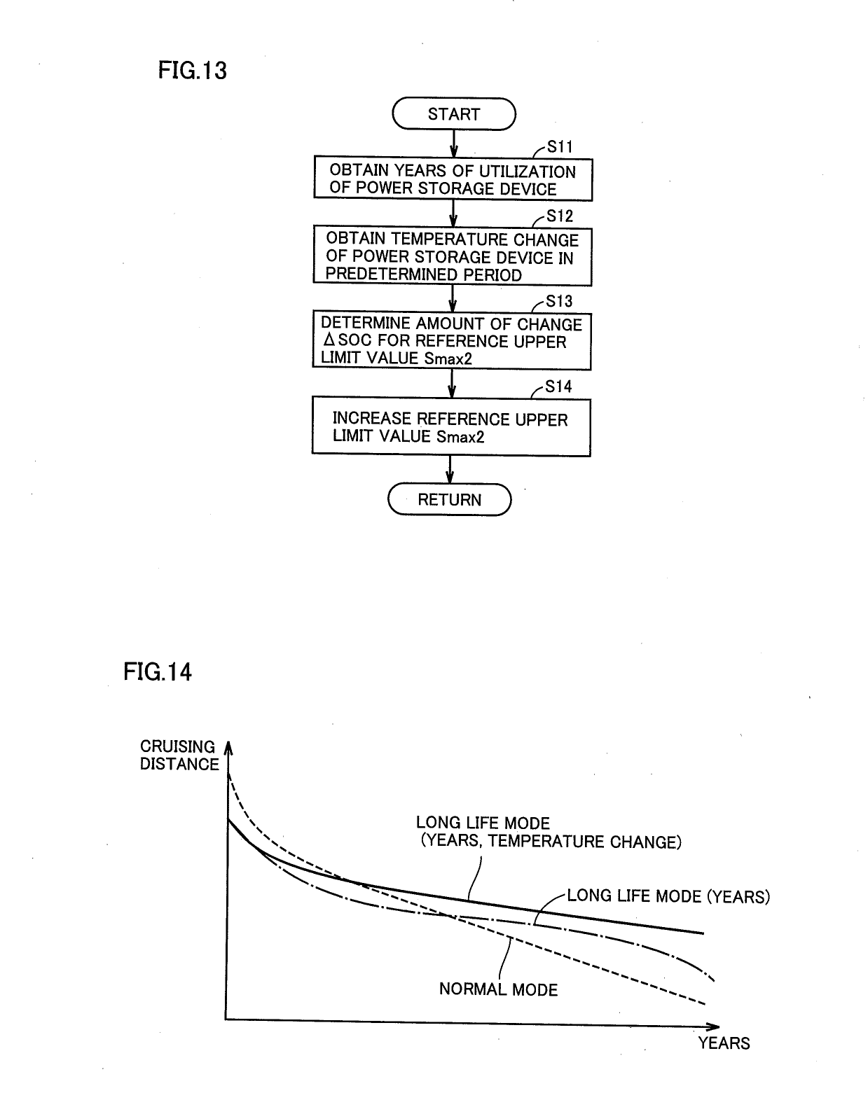

FIG. 13 is a flowchart illustrating the process in step S04 of FIG. 12 more in detail. This flowchart is performed whenever a certain time elapses or whenever a predetermined condition is established, in the case where the charging mode is set at the long life mode.

Referring to FIG. 13, in a step S11, reference range setting unit 160 obtains measurement value CNT of the years of utilization of power storage device 10 from deterioration diagnosis unit 120. Further, in a step S12, reference range setting unit 160 obtains the temperature change of power storage device 10 in the predetermined period, based on the battery data (battery temperature Tb) from monitoring unit 11.

In a step S13, reference range setting unit 160 sets amount of change ΔSOC for reference upper limit value Smax2 based on the obtained years of utilization of power storage device 10 and temperature change in the predetermined period. Specifically, reference range setting unit 160 makes reference to the amount-of-change setting map shown in FIG. 8 for the upper limit value so as to set amount of change ΔSOC for the upper limit value corresponding to the obtained measurement value of the years of utilization of power storage device 10 and temperature change in the predetermined period.

In a step S14, reference range setting unit 160 increases reference upper limit value Smax2 in accordance with amount of change ΔSOC set in step S13.

FIG. 14 is a conceptual view illustrating the cruising distance of the electrically powered vehicle, which can be achieved in accordance with the SOC control in the first embodiment. The solid line of FIG. 14 represents the cruising distance of electrically powered vehicle 5 when increasing reference upper limit value Smax2 based on the years of utilization of power storage device 10 and the temperature change in the predetermined period. The dotted line of FIG. 14 represents the cruising distance of electrically powered vehicle 5 when the reference upper limit value is fixed to Smax1 (corresponding to the normal mode). The alternate long and short dash line of FIG. 14 represents the cruising distance of electrically powered vehicle 5 when reference upper limit value Smax2 is increased based on only the years of utilization of power storage device 10.

Referring to FIG. 14, in the case where the reference upper limit value is fixed to Smax1, the cruising distance is decreased as the years of utilization of power storage device 10 become longer. This is because deterioration of power storage device 10 (decrease of the fully charged capacity) proceeds by charging power storage device 10 assuming that reference upper limit value Smax1 is a limit.

In contrast, in the case where reference upper limit value Smax2 is increased at a predetermined timing based on the years of utilization of power storage device 10, the amount of charges in power storage device 10 can be increased. Accordingly, the cruising distance can be made longer.

Further, in the case where the amount of increase of reference upper limit value Smax2 is changed in accordance with the temperature change of power storage device 10 obtained whenever the predetermined period elapses, progression of deterioration of power storage device 10 can be suppressed as compared with the case where the amount of increase is fixed. Accordingly, even when the years of utilization of power storage device 10 become long, a larger amount of electric power can be stored in power storage device 10. As a result, electrically powered vehicle 5 can travel a longer cruising distance than that in the case where reference upper limit value Smax2 is increased based on only the years of utilization of power storage device 10.

As described above, according to the electrically powered vehicle in the first embodiment of the present invention, when the deterioration parameter (the years of utilization of the power storage device and/or the traveling distance of the electrically powered vehicle) of the power storage device reaches a predetermined level, the amount of change for the reference upper limit value is changed in accordance with the power storage device's temperature change obtained whenever the predetermined period elapses, in the configuration of increasing the SOC reference upper limit value. Thus, the reference upper limit value can be set finely in a reflection of the temperature change of the power storage device affecting the battery performance, thereby suppressing progression of deterioration of the power storage device. As a result, the cruising distance of the electrically powered vehicle can be made longer.

### Second Embodiment

In the first embodiment, the amount of change for the SOC reference upper limit value is changed in accordance with the temperature change of the power storage device so as to suppress progression of deterioration of the power storage device and secure the cruising distance. In a second embodiment, the following describes charging control by which progression of deterioration of the power storage device can be further suppressed.

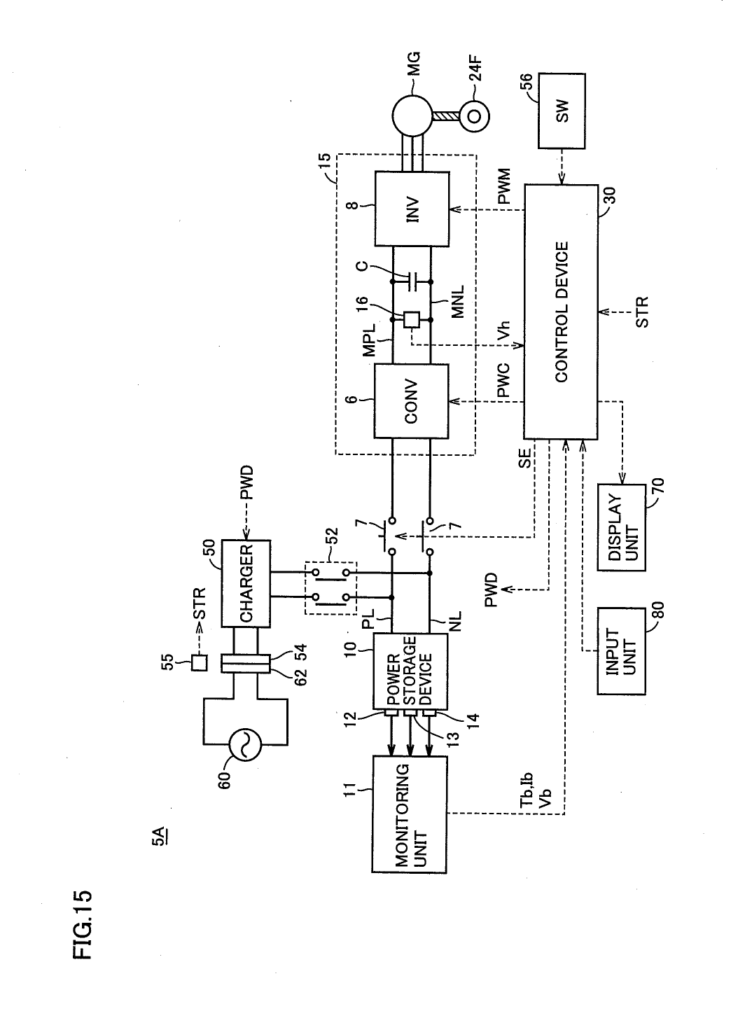

FIG. 15 is a schematic configuration diagram of an electrically powered vehicle 5A according to the second embodiment of the present invention. As compared with electrically powered vehicle 5 shown in FIG. 1 according to the first embodiment, electrically powered vehicle 5A according to the second embodiment further includes a display unit 70 and an input unit 80.

Display unit 70 is a user interface for displaying a recommended value for reference upper limit value Smax, calculated in the below-described charging control, for external charging. Display unit 70 includes a liquid crystal display and the like.

Input unit 80 is a user interface for setting a travel destination of electrically powered vehicle 5A and information regarding the destination such as a travel route in the below-described charging control. The information regarding the destination set by input unit 80 is transmitted to control device 30.

In FIG. 15, display unit 70 and input unit 80 are illustrated as separate elements, but they may be integrated into one element as a navigation system, for example.

As illustrated in FIG. 3, in view of deterioration, it is not preferable that the SOC of power storage device 10 is continued to be relatively high for a long time. For example, in the case where power storage device 10 is fully charged whenever external charging is performed, the SOC of power storage device 10 is maintained at the substantially fully charged state for a long time until start of the next traveling. This may result in progression of deterioration of power storage device 10.

However, by charging power storage device 10 up to the fully charged state, it is possible to secure an allowed traveling distance for the next traveling using the electric power stored in power storage device 10. Therefore, in the case where a distance of the next traveling is expected to be relatively long, there is a benefit in doing so. However, in the case where the distance of the next traveling is expected to be relatively short, power storage device 10 is charged to have an unnecessary amount of electric power exceeding an amount of electric power required for the next traveling. Such unnecessary charging may result in progression of deterioration of power storage device 10.

To address this, in the second embodiment, when input unit 80 receives information regarding a destination while the charging mode is set at the long life mode, reference upper limit value Smax2 is set at a value set based on a necessary amount of charges to power storage device 10 for arrival at the destination.

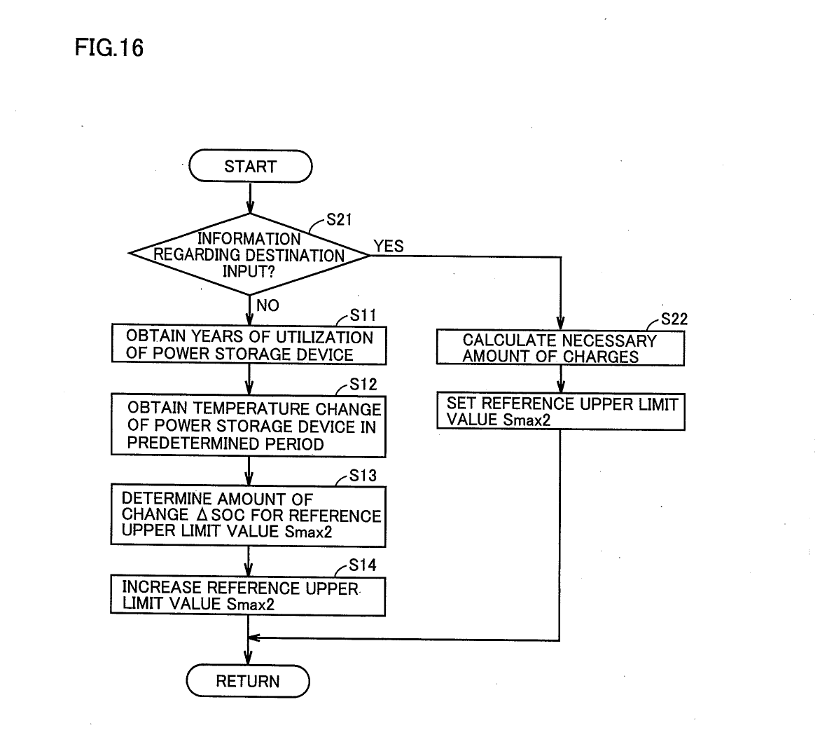

FIG. 16 is a flowchart illustrating charging control for power storage device 10 by the electrically powered vehicle according to the second embodiment of the present invention. FIG. 16 is a flowchart illustrating the process of step S04 of FIG. 12 more in detail. This flowchart is performed whenever a certain time elapses or a predetermined condition is established, in the case where the charging mode is set at the long life mode through steps S01 to S03 of FIG. 12.

Referring to FIG. 16, reference range setting unit 160 determines in a step S21 whether or not an expected destination for the next traveling or information regarding the destination such as a travel route has been provided to input unit 80 by the user's operation. In the case where no information regarding the expected destination for the next traveling has been provided to input unit 80 (NO in step S21), reference range setting unit 160 performs steps S11 to S14 in the same manner as in FIG. 13 so as to set amount of change ΔSOC for reference upper limit value Smax2 in accordance with the obtained years of utilization of power storage device 10 and temperature change in the predetermined period, and increase the reference upper limit value from default value S0 by amount of change ΔSOC.

Meanwhile, in the case where the information regarding the expected destination for the next traveling has been provided to input unit 80 (YES in step S21), based on the obtained information regarding the destination from input unit 80, reference range setting unit 160 makes reference to geographical map database and past traveling history data contained in a storage unit (not shown) so as to calculate electric power to be consumed if electrically powered vehicle 5 travels to the destination along the travel route. In a step S22, based on the calculated electric power consumption, reference range setting unit 160 calculates a target value for an amount of charges necessary to externally charge power storage device 10. Reference range setting unit 160 sets reference upper limit value Smax2 based on the target value for the necessary amount of charges.

By performing the control in accordance with such a process, reference upper limit value Smax2 is set to attain the necessary amount of charges in accordance with the next expected traveling, and external charging is performed in accordance with reference upper limit value Smax2 thus set. As a result, unnecessary charging is not performed as compared with a case where power storage device 10 is charged up to the fully charged state, thereby suppressing progression of deterioration of power storage device 10. In this way, the cruising distance of the electrically powered vehicle can be made longer.

### MODIFICATION OF SECOND EMBODIMENT

Described in the second embodiment is the configuration in which reference range setting unit 160 sets reference upper limit value Smax2 based on the information regarding the destination and provided by the user to input unit 80. Described in the modification of the second embodiment is a configuration in which a destination candidate is displayed on display unit 70 in association with a recommended value of reference upper limit value Smax2 and the user directly sets reference upper limit value Smax2 via input unit 80.

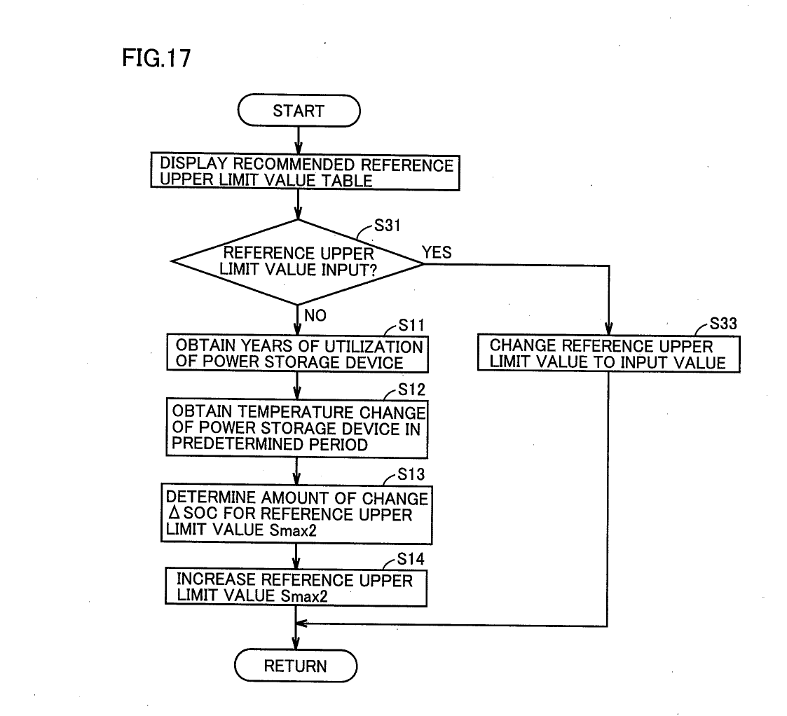

FIG. 17 is a flowchart illustrating charging control for power storage device 10 by an electrically powered vehicle according to the modification of the second embodiment of the present invention. FIG. 17 is a flowchart illustrating the process in step S04 of FIG. 12 more in detail. This flowchart is performed whenever a certain time elapses or a predetermined condition is established, in the case where the charging mode is set at the long life mode through steps S01 to S03 of FIG. 12.

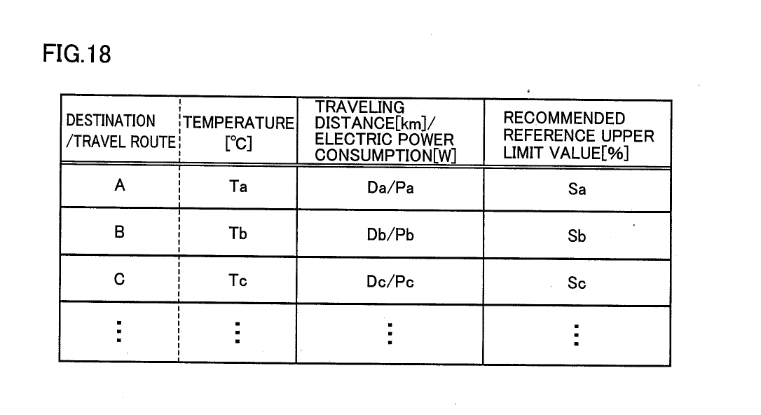

Referring to FIG. 17, on the screen of display unit 70, reference range setting unit 160 displays destination candidates, which are selectable by the user, in association with recommended values (hereinafter, also referred to as “recommended reference upper limit values”) of reference upper limit values Smax2 set based on amounts of charges necessary for the candidates. FIG. 18 shows exemplary destination candidates and recommended reference upper limit values displayed on display unit 70. In the figure, the plurality of destination candidates and travel route candidates selectable by the user are displayed. In the case where there are a plurality of travel routes for one destination, all the selectable travel routes are displayed. For each destination candidate and travel route candidate, traveling distance to the destination and power consumption are displayed. The traveling distance and power consumption are calculated with reference to the geographical map database and past traveling history data stored in the storage unit. It should be noted that the past traveling history data includes information regarding outside temperature in the traveling. This is due to the following reason. That is, when the outside temperature is high or low, an air conditioning device (air conditioner) is operated in order to air-condition the passenger compartment, so that an amount of electric power to be consumed by whole of electrically powered vehicle 5 for arrival at the destination is increased as compared with a case where the air conditioning device is non-operational.

Thus, in FIG. 18, the outside temperature information in the traveling is displayed together with the destination candidates and travel route candidates. The traveling distances, power consumptions, and recommended reference upper limit values are displayed in association with these pieces of information. The term “recommended reference upper limit value” is intended to indicate a reference upper limit value recommended as a reference upper limit value suitable to provide a necessary amount of charges calculated based on traveling distance and power consumption.

Reference range setting unit 160 has a table (hereinafter, also referred to as “recommended reference upper limit value setting table”) in which the destination candidates and recommended reference upper limit values shown in FIG. 18 are associated with one another. When reference range setting unit 160 determines that signal STR has been generated and external charging can be started, reference range setting unit 160 displays the recommended reference upper limit value setting table on the screen of display unit 70. By making reference to the recommended reference upper limit value setting table displayed on display unit 70, the user can set an appropriate reference upper limit value for the next expected destination and travel route.

Turning back to FIG. 17, reference range setting unit 160 determines in a step S31 whether or not the user operates to provide the reference upper limit value to input unit 80. In the case where no reference upper limit value has been provided to input unit 80 (NO in step S31), reference range setting unit 160 performs steps S11 to S14 in the same manner as in FIG. 13 so as to set amount of change ΔSOC for reference upper limit value Smax2 in accordance with the obtained years of utilization of power storage device 10 and temperature change in the predetermined period, and increase the reference upper limit value from default value S0 by amount of change ΔSOC.

On the other hand, in the case where the reference upper limit value has been provided to input unit 80 (YES in step S31), reference range setting unit 160 sets in a step S33 the value obtained from input unit 80, as the reference upper limit value.

By performing the control in accordance with such a process, reference upper limit value Smax2 is set to attain the necessary amount of charges in accordance with the next expected traveling, and external charging is performed in accordance with reference upper limit value Smax2 thus set. As a result, progression of deterioration of power storage device 10 can be suppressed, whereby the cruising distance of the electrically powered vehicle can be made longer.

It should be noted that the electrically powered vehicle to which the charging control for the power storage device of the vehicle in the present embodiment is applied is not limited to the electric vehicle illustrated in FIG. 1. The present invention can be generally and commonly applied to electrically powered vehicles such as a hybrid vehicle as well as electric vehicle and fuel cell vehicle having no engine, irrespective of the number of motors (motor generators) provided therein and configuration of the driving system, as long as each of the electrically powered vehicles is configured to be capable of charging the power storage device of the vehicle using an external power source.

The embodiments disclosed herein are illustrative and non-restrictive in any respect. The scope of the present invention is defined by the terms of the claims, rather than the embodiments described above, and is intended to include any modifications within the scope and meaning equivalent to the terms of the claims.

### INDUSTRIAL APPLICABILITY

The present invention can be applied to an electrically powered vehicle capable of charging a mounted power storage device using an external power source.

### REFERENCE SIGNS LIST

5, 5A: electrically powered vehicle; 6: converter; 7: system main relay; 8: inverter; 10: power storage device; 11: monitoring unit; 12: temperature sensor; 13, 16: voltage sensor; 14: current sensor; 15: power control unit; 24F: driving wheel; 30: control device; 50: charger; 52: charging relay; 54: connector receiving portion; 55: sensor; 56: switch; 60: external power source; 62: connector portion; 70: display unit; 80: input unit; 110: state estimating unit; 120: deterioration diagnosis unit; 150: charging/discharging control unit; 160: reference range setting unit; 170: charging/discharging upper limit value setting unit; 180: control range setting unit; 200: traveling control unit; 260: inverter control unit; 270: converter control unit; C: smoothing capacitor; MG: motor generator; MNL: negative bus; MPL: positive bus; NL: negative line; PL: positive line.

1. An electrically powered vehicle comprising:
a rechargeable power storage device;
a motor configured to receive electric power supplied from said power storage device and generate vehicle driving power;
an external charging structure configured to charge said power storage device using a power source external to the vehicle; and
a control device that controls the charging of said power storage device such that a value of state of charge of said power storage device does not exceed an upper limit value of the value of state of charge during the charging of said power storage device by said external charging structure, said upper limit value being defined in association with a fully charged state of said power storage device,
said control device being configured to increase said upper limit value in accordance with progression of deterioration of said power storage device,
an amount of change for said upper limit value being set to be valuable in accordance with a temperature change of said power storage device.

2. The electrically powered vehicle according to claim 1, wherein in a case where the temperature of said power storage device is changed within a high temperature range, said control device sets said amount of change for said upper limit value at a value smaller than a value set in a case where the temperature of said power storage device is changed within a low temperature range.

3. The electrically powered vehicle according to claim 1, wherein
when a utilization period of said power storage device reaches a first period, said control device is configured to increase said upper limit value, and change said amount of change for said upper limit value in accordance with the temperature change of said power storage device, the temperature change being obtained whenever a second period elapses, and
said second period is set at a period shorter than said first period.

4. The electrically powered vehicle according to claim 1, further comprising an input unit configured to be capable of receiving an instruction regarding said upper limit value from a user, wherein
said instruction regarding said upper limit value includes an instruction for restricting said upper limit value to be equal to or more than a predetermined lower limit value.

5. The electrically powered vehicle according to claim 1, further comprising an input unit configured to be capable of receiving information regarding a destination, wherein
when said input unit receives said information regarding said destination, said control device sets said upper limit value at a value set based on a necessary amount of charges to said power storage device for arrival at said destination.

6. The electrically powered vehicle according to claim 5, wherein said control device sets the necessary amount of charges based on an amount of electric power to be consumed by the electrically powered vehicle for arrival at said destination.

7. The electrically powered vehicle according to claim 5, further comprising a display unit configured to be capable of displaying a destination candidate and a recommended value of said upper limit value in association with each other, said destination candidate being selectable by a user, said recommended value being set for the candidate based on the necessary amount of charges to said power storage device, wherein
said information regarding said destination includes an instruction regarding said upper limit value from the user.

8. A method for controlling an electrically powered vehicle,
the electrically powered vehicle including:
a rechargeable power storage device;
a motor configured to receive electric power supplied from said power storage device and generate vehicle driving power; and
an external charging structure configured to charge said power storage device using a power source external to the vehicle,
the method comprising the steps of:
controlling the charging of said power storage device such that a value of state of charge of said power storage device does not exceed an upper limit value of the value of state of charge during the charging of said power storage device by said external charging structure, said upper limit value being defined in association with a fully charged state of said power storage device;
increasing said upper limit value in accordance with progression of deterioration of said power storage device; and
changing an amount of change for said upper limit value in accordance with a temperature change of said power storage device.
